(19) United States
(12) Patent Application Publication
(10) Pub. No.: US 2024/0356214 A1
(43) Pub. Date: Oct. 24, 2024

(54) BROADBAND DUAL POLARIZED SCAN INVARIANT IMPEDANCE PLANAR ANTENNA ARRAY ELEMENT FOR ELECTRONICALLY SCANNED ARRAY APPLICATIONS

(71) Applicant: SMITHS INTERCONNECT, INC., Tampa, FL (US)

(72) Inventor: David Steward, Camarillo, CA (US)

(21) Appl. No.: 18/683,489

(22) PCT Filed: Aug. 30, 2022
(86) PCT No.: PCT/US2022/041982

§ 371 Date: Feb. 13, 2024

Related U.S. Application Data
(60) Provisional application No. 63/238,706, filed on Aug. 30, 2021.

(51) Int. Cl. H01Q 3/08; H01Q 21/00; H01Q 21/06

(52) U.S. Cl. CPC H01Q 3/08; H01Q 21/0037; H01Q 21/065

(57) ABSTRACT

A directionally-tunable antenna element of an antenna is provided. The directionally-tunable antenna element includes a feed structure, a coupling structure, and a ridge structure. The coupling structure is disposed between the feed structure and the ridge structure and communicates electromagnetic energy between the feed structure and the ridge structure. These structures address challenges associated with satellite tracking and frequent satellite handoffs in an electronically scanned array (ESA). The disclosed aspects enhance performance of ESA antenna systems, addressing shortcomings of ESA antenna systems yet while addressing the satellite tracking and frequent satellite handoff challenges. The disclosed aspects provide for antennas with highly efficient useable gain bandwidth, high scan angle performance, and consistent and high cross polar isolation over a full scan angle range.

### CROSS-REFERENCE TO RELATED APPLICATIONS

This application is based upon and claims priority to U.S. provisional patent application 63/238,706 entitled “BROADBAND DUAL POLARIZED SCAN INVARIANT IMPEDANCE PLANAR ANTENNA ARRAY ELEMENT FOR ELECTRONICALLY SCANNED ARRAY APPLICATIONS” and filed on Aug. 30, 2021, the entire content of which is incorporated herein by reference.

### BACKGROUND

### 1. Field

This disclosure relates generally to antennas, and more specifically, to planar antenna array elements.

### 2. Description of the Related Art

The airborne market for fuselage mounted Satcom, Inmarsat, and other broadband antennas has expanded in the last several years with access to broadband satellite. Examples of these airborne antennas include parabolic dishes, patch arrays and fixed waveguide arrays. Most of these antenna systems are fixed beam systems mounted under a radome on a two-axis positioner that tracks a geostationary (GEO) satellite. The low-profile nature of airborne antennas limits the size and shape of the aperture, thereby limiting operational performance of the antenna because of adjacent satellite interference, added noise, and/or jamming.

Additionally, airborne antenna users are increasingly utilizing satellites in Medium Earth Orbit (MEO) and Low Earth Orbit (LEO) constellations for various advantages such as lower signal latency, and higher signal strength. These satellite platforms pose additional challenges to the fuselage mounted antenna, however. Unlike a GEO satellite which is in a fixed position, MEO and LEO satellites have orbital periods that can range from 20 to 40 minutes. The antenna must continuously hand-off from one satellite to another in the constellation. This becomes impractical/problematic for fixed beam mechanically steered moving vehicle mounted antennas.

Thus, there is a need for systems and methods to address shortcomings of extant antenna systems to facilitate frequent hand-off from one satellite to another.

### SUMMARY

A directionally-tunable antenna element of an antenna may include various features. For instance, a feed structure, a coupling structure, and a ridge structure may be provided. The feed structure may be connectable to at least one of a transmitter and a receiver. The coupling structure may be adjacent to the feed structure. The ridge structure may be adjacent to the coupling structure. The coupling structure may be disposed between the feed structure and the ridge structure. The coupling structure may be configured to communicate electromagnetic energy between the feed structure and the ridge structure. The coupling structure may be a dielectric material that capacitively couples the feed structure to the ridge structure.

The ridge structure may include two metal layers made of a first metal and sandwiching a substrate layer. A plurality of through-hole vias may connect the two metal layers through the substrate layer. The through-hole vias are made of the first metal. The coupling structure may be a dielectric material that capacitively couples the feed structure to the ridge structure. An outermost metal layer of the two metal layers may be a metal edge lying in a plane surrounding and defining a central opening. The outermost metal layer may include a center patch element that is a metal pad in the central opening and separated from the metal edge.

In various embodiments, the feed structure has a plurality of apertures and the ridge structure has a plurality of apertures. The apertures of the feed structure and the apertures of the ridge structure have same shapes and are aligned to electromagnetically couple the feed structure to the ridge structure. The feed structure may include a first input to receive a first electromagnetic signal and a second input to receive a second electromagnetic signal comprising the first electromagnetic signal with a phase delay. The first input and the second input may be capacitively coupled inputs.

In various embodiments, the feed structure includes a first input connected to a plurality of reflective stubs by at least one phasing trace and a second input connected to the plurality of reflective stubs by at least one further phasing trace. Each of the at least one phasing trace and the at least one further phasing trace collectively mix the first input and the second input to cause an electromagnetic signal at the first reflective stub to have a different phase than the electromagnetic signal at the second reflective stub. A first electromagnetic signal source may be included that that tunes an amplitude and phase of a first portion of the electromagnetic signal at the first input and a second portion of the electromagnetic signal at the second input to cause the directionally-tunable antenna element to steer an emitted beam of the electromagnetic signal responsive to the tuning.

Multiple planar directionally-tunable antenna elements may be combined into an array to provide an antenna. The antenna may be configured to steer one or more lobe of the antenna in response to mixing of a plurality of (i) inputs or (ii) outputs to the antenna.

A method of manufacturing a directionally-tunable antenna element of an antenna may be provided. The antenna may be an array of directionally-tunable antenna elements. The antenna may be configured to steer one or more lobe of the antenna in response to mixing of a plurality of (i) inputs or (ii) outputs to the antenna. The method may include providing a feed structure configured to receive at least one of the plurality of (i) the inputs or (ii) the outputs to the antenna. The method may include providing a coupling structure adjacent to the feed structure. The method may include providing a ridge structure adjacent to the coupling structure. The coupling structure may be disposed between the feed structure and the ridge structure. The coupling structure may be configured to communicate electromagnetic energy between the feed structure and the ridge structure.

### BRIEF DESCRIPTION OF THE DRAWINGS

Other systems, methods, features, and advantages of the present invention will be or will become apparent to one of ordinary skill in the art upon examination of the following figures and detailed description.

FIGS. 1A-D depict views of a directionally-tunable antenna element, in accordance with various embodiments;

FIGS. 2A-B illustrate breakaway views of the directionally-tunable antenna element and three functional components of the directionally-tunable antenna element, in accordance with various embodiments;

FIG. 3 depicts an antenna made of an array of directionally-tunable antenna elements, in accordance with various embodiments;

FIG. 4A illustrates a ridge structure, in accordance with various embodiments;

FIG. 4B illustrates a ridge structure, coupling structure, and feed structure with an electromagnetic field, in accordance with various embodiments;

FIG. 4C shows a side view of the ridge structure and representative L-C circuit components, in accordance with various embodiments;

FIG. 4D illustrates a Smith chart showing that the impedance match of the ridge structure depends on its thickness in a band of interest, in accordance with various embodiments;

FIGS. 5A-B illustrate a chart of return loss and a corresponding Smith chart, in accordance with various embodiments;

FIG. 6A-E shows a collection of Smith charts illustrating complex impedance plots at various scan angles, in accordance with various embodiments;

FIG. 6F shows a scan angle plot, in accordance with various embodiments;

FIGS. 7A-B show simplified diagrams of different feed structure configurations, in accordance with various embodiments;

FIGS. 8A-B show a basic configuration of a directionally-tunable antenna element with FIG. 8A showing a feed summation path that produces a co-polar field and FIG. 8B showing a feed difference path that produces a cross-polar field, in accordance with various embodiments;

FIGS. 9A-B illustrate simulated field patterns showing co-polar summation of fields and cross-polar cancelation of fields, in accordance with various embodiments;

FIGS. 10A-C illustrate electric field coupling mechanisms between a feed structure and a ridge structure, in accordance with various embodiments;

FIG. 11 illustrates a capacitive coupling of the feed structure with the ridge structure, in accordance with various embodiments; and

FIG. 12 illustrates a method of manufacturing a directionally-tunable antenna element of an antenna comprising an array of directionally-tunable antenna elements.

### DETAILED DESCRIPTION

Efforts to address the challenges associated with satellite tracking and frequent satellite handoff(s) include utilization of an electronically scanned array (ESA). Systems and methods provided herein further enhance performance of ESA antenna systems, addressing shortcomings of ESA antenna systems yet while addressing the satellite tracking and frequent satellite handoff challenges. Systems and methods herein provide for ESA antennas with highly efficient useable gain bandwidth covering the SATCOM band, high scan angle performance, and consistent and high cross polar isolation over a full scan angle range. Systems and methods herein facilitate development of physically robust mobile antenna architectures. This disclosure provides for true planar circuit board technology as a core construction technology.

Various electronically beam steered array systems (AESA) under development, or that have been in use typically incorporate legacy microstrip patch radiator designs. Either the patch uses a direct feed, or some variation of aperture or capacitive coupling, and additional layers of parasitic metal layers to enhance the bandwidth of the antenna. The patch antenna element is adequate for system flat gain bandwidths of 7-10%, and cross polar isolation bandwidths in the range of 5-6%. However, modern satellite communication systems require uniform gain and cross polar isolation bandwidths to reach 17-18% in the case of the receive band of Ka systems.

In any competitive electronically steered system, the directionally-tunable antenna element must also be spaced approximately a half wavelength apart to scan off zenith to 60 or 70 degrees without encountering degenerate radiating modes, more commonly termed grating lobes.

Scanning requirements impose additional constraints on the operation of the element. With dual linear antennas, it is preferable that the element polarizations have co-equal phase centers. This allows the system to scan off zenith without introducing additional phase errors into the beam steering algorithm. Most important, however, is the problem with scan angle dependent mutual coupling between elements that may introduce scan angle loss into the system and in some cases cause scan blindness, or severe degradation of the aperture gain.

The construction of the antenna is also of concern particularly with the added environmental stresses of fuselage mounted aviation antennas. Planar circuit board antenna architectures are ideal in that they can interface directly with the beam steering and other circuitry in one board. Other types of antennas such as the Planar Ultra-Wideband Modular Array (PUMA) structures typically are not fully planar in that they are comprised of a vertical dipole arrangement with separate foam layers. This kind of mixed substrate structure does not lend itself to planar architectures.

The Substrate Integrated Scan Invariant Impedance Matched (SIWAIM) antenna element introduced in this work satisfactorily addresses the shortcomings of patch antenna elements particularly as it relates to ultra-low mutual coupling between elements, high bandwidth flat gain and cross polar performance, scan invariant impedance, a planar design that lends itself well to system level integration with beamforming and other components on the same board, and co-located phase centers. Additionally, the SIWAIM architecture is similar in layer count to a patch element with two parasitic layers, thereby not introducing more complexity to the system.

This disclosure describes a dual polarized antenna directionally-tunable antenna element in an array of identical elements and that functions cooperatively with adjacent elements in an electronically steered array environment and provides stable active impedance match over a wide scan volume and wide bandwidth. A substrate integrated scan angle invariant impedance matching structure, a reflective feed and a coupling mechanism between the feed and the impedance structure realizes these properties. The entire element structure is contained in a single planar circuit board architecture and is integral with the circuitry for beam steering, amplifiers, and other electronics. A signal is applied to one, or both polarized inputs with phase and amplitude from a beam forming network in relationship to the other elements in the array to produce an overall radiation pattern that points in a desired elevation/azimuth direction, and complies with performance measures such as polarization sense, peak pointing direction, cross polar isolation, EIRP and G/T ratio.

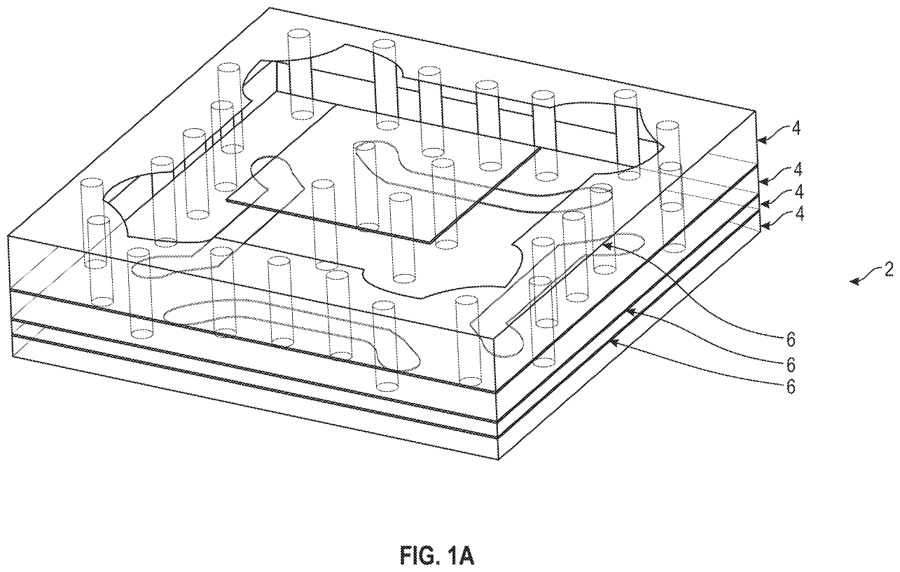

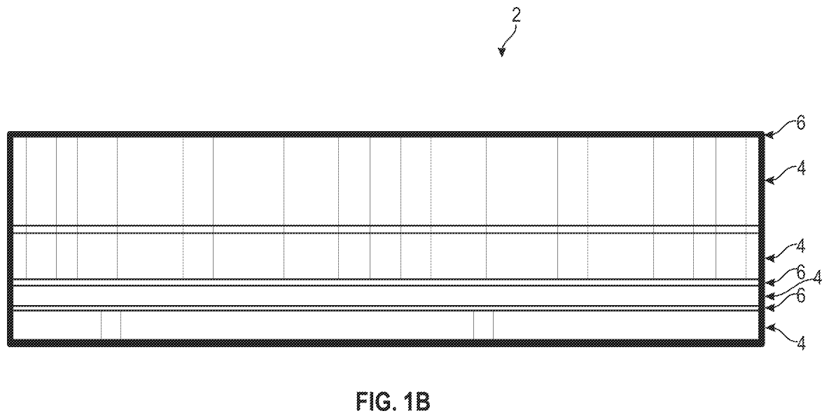

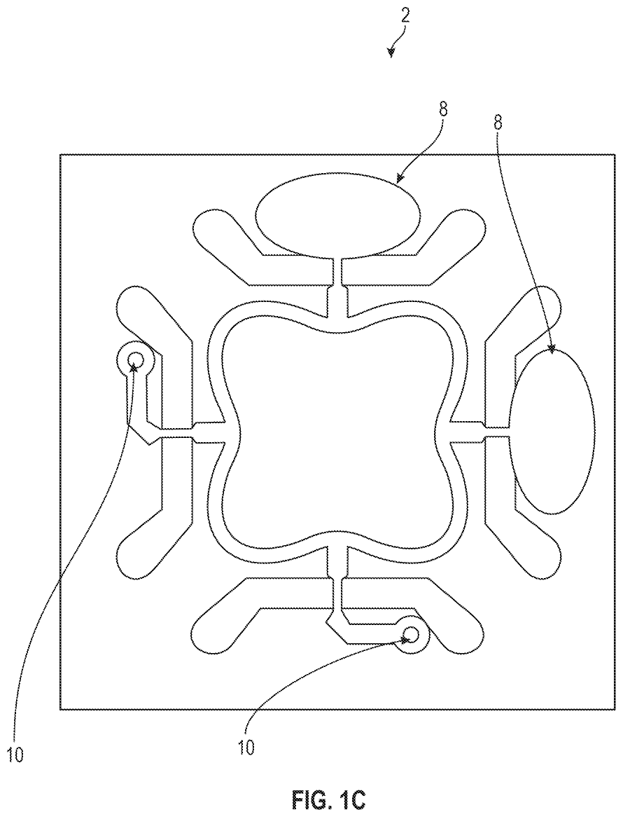

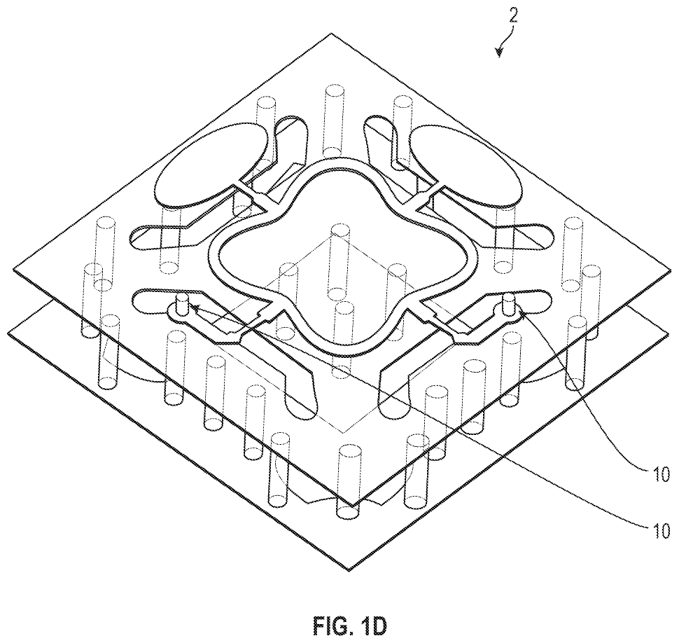

FIGS. 1A-D show views of the SIWAIM antenna element (directionally-tunable antenna element 2). The directionally-tunable antenna element 2 includes a series of layers. For example, a plurality of substrate layers 4 and metal layers 6 are stacked. Reflective stubs 8 are connected to feed points 10 that provide an electromagnetic connection for other components to connect to the directionally-tunable antenna element 2, such as a beam forming network of a transmitter and/or receiver. Aspects of the directionally-tunable antenna element 2 will be discussed in greater detail with reference to further figures herein. Moreover, reference to metal layer 6 is made in further figures and discussion below.

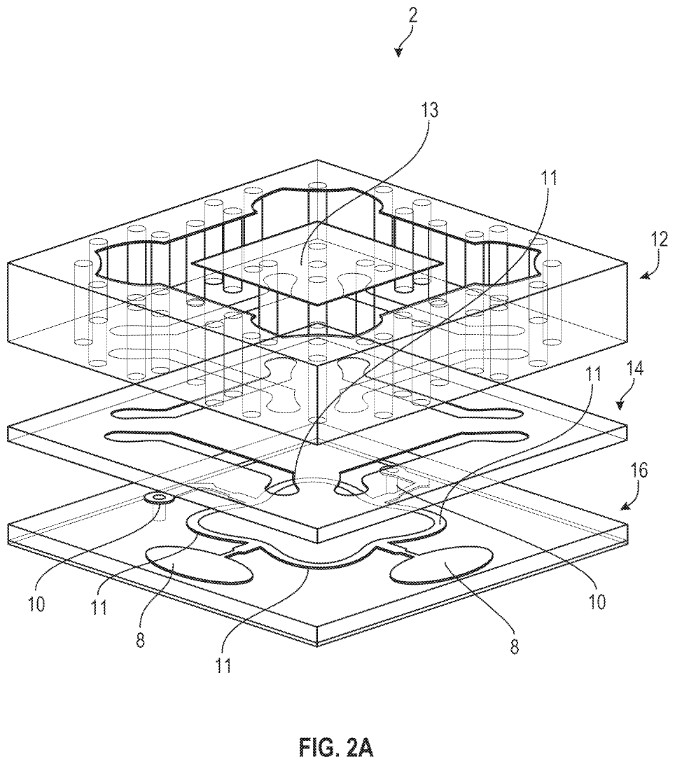

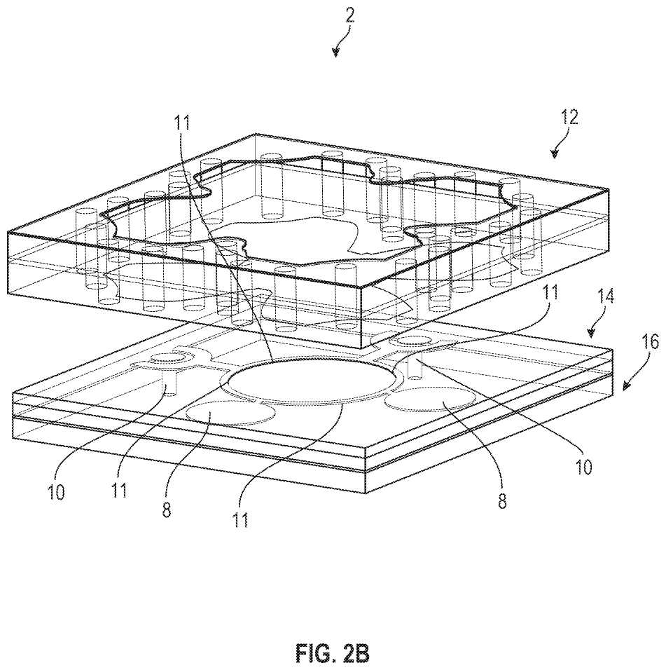

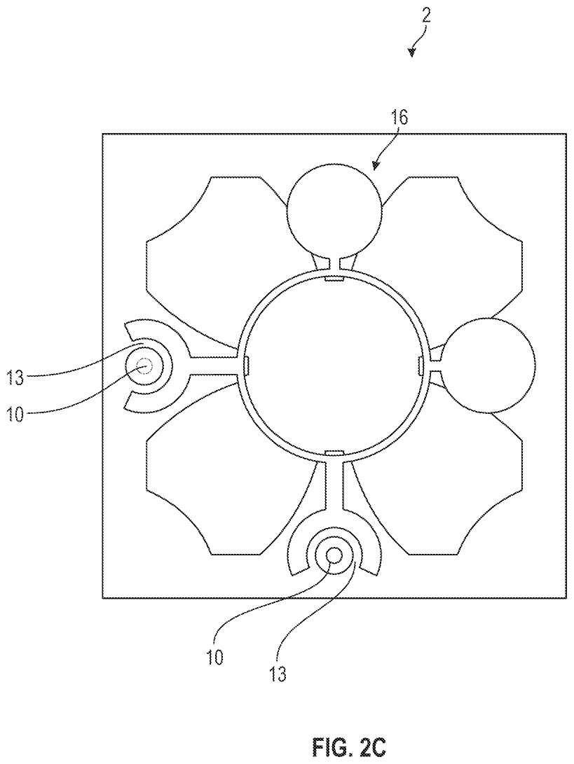

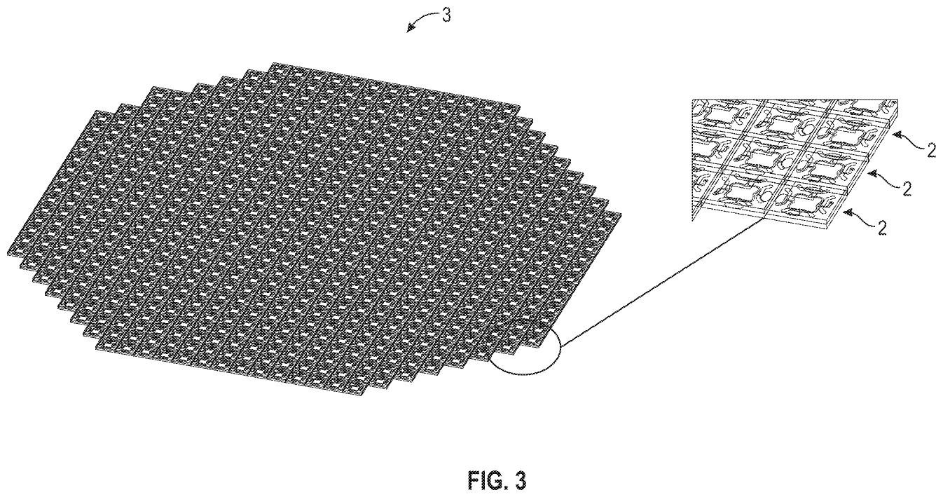

FIGS. 2A-B illustrate breakaway views of the directionally-tunable antenna element 2 and three functional components of the directionally-tunable antenna element 2. This directionally-tunable antenna element 2 is the fundamental part of a larger array 3 forming an antenna, as FIG. 3 illustrates. Briefly, larger array 3 comprises a 56 by 56 element array, though an array 3 of any size may be provided. Maximum scan angle without introducing grating lobes determines the element spacing, which is typically around a half wavelength.

With renewed attention to FIGS. 2A-B, the directionally-tunable antenna element 2 is shown having a feed structure 16, a coupling structure 14, and a ridge structure 12. The feed structure 16 comprises a layer of the directionally-tunable antenna element 2 configured to feed electromagnetic energy into or out of the directionally-tunable antenna element 2. The feed structure 16 is structured to match an impedance of the directionally-tunable antenna element 2 (and consequently, a larger array 3 as illustrated in FIG. 3) to a feedline. The feed structure 16 may comprise one or more stubs 8. The stubs 8 may be reflective stubs 8 configured to steer the radiation pattern of the directionally-tunable antenna element 2, provide impedance matching, and the like.

The stubs 8 may be connected via phasing traces 11 to one or more feed points 10. Electromagnetic energy may be injected into or received from the feed points 10. The electromagnetic energy may have a phase and amplitude. In various instances, electromagnetic energy of different phase and amplitude is injected into different feed points 10 and/or phase and/or amplitude filtering and/or mixing may be applied to electromagnetic energy received from the feed points 10. This electromagnetic energy may travel along the phasing traces 11, with the phasing traces 11 having various pre-determined lengths, such that the reflective stubs 8 operate in concert to direct lobes of a radiation pattern of the directionally-tunable antenna element 2, steering the radiation pattern of the directionally-tunable antenna element 2, and/or matching an impedance.

A coupling structure 14 may be disposed adjacent to the feed structure 16 and adjacent to a ridge structure 12. For instance, a coupling structure 14 may be sandwiched between at least a portion of the feed structure 16 and at least a portion of the ridge structure 12. The coupling structure 14 may couple electromagnetic energy between the ridge structure 12 and the feed structure 16. Various further aspects of the coupling structure 14 will be discussed herein.

Finally, a ridge structure 12 may be provided. The ridge structure 12 may comprise an outermost structure of the directionally-tunable antenna element 2 configured to match an impedance of the directionally-tunable antenna element 2 to surrounding space adjacent the directionally-tunable antenna element 2. In FIG. 2A, a center patch element 13 may comprise a metal pad of the ridge structure 12 disposed generally centered and surrounded by a surrounding aspect of the ridge structure 12.

In FIG. 2B, a further embodiment of the directionally-tunable antenna element 2 is provided. The directionally-tunable antenna element 2 includes the same ridge structure 12 discussed above but does not contain the center patch metallization (center patch element 13 (FIG. 2A)). In various embodiments, this configuration typically works well with a capacitively coupled feed, as illustrated by the dielectric gap incorporated into the feed points 10. In such an instance a feed structure 16 may include a dielectric gap 17 as illustrated in FIG. 2C. This configuration is a Dual Linear Polarized Reflection Feed. The configuration includes the basic reflectively matched half wavelength combiner, but the input terminates in a planar capacitive coupling section. This adds a capacitive shift to the input to translate a predominantly inductive complex impedance to a complex normalized impedance near the real value of 1. Thus, the feed structure 16 may include dielectric gaps 17 in some embodiments, and exclude dielectric gaps 17 in other embodiments, though a ridge structure 12 omitting the center patch element 13 of FIG. 2A is particularly suited for the feed structure 16 of FIG. 2C including dielectric gaps 17 in the feed structure 16.

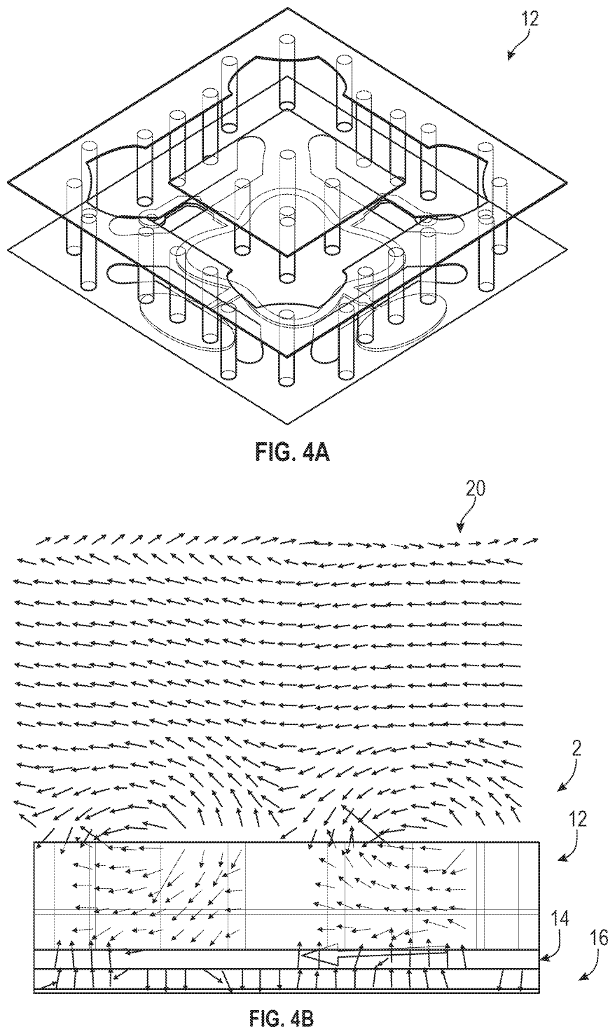

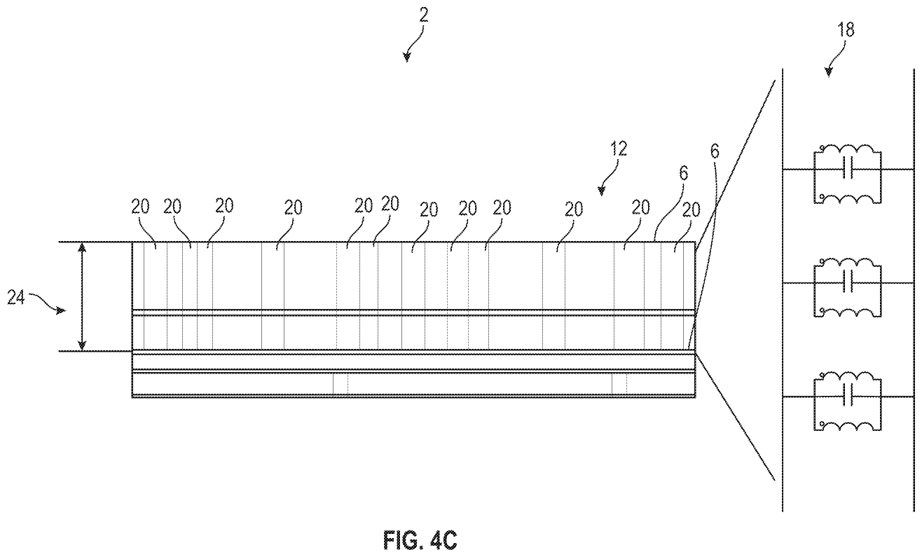

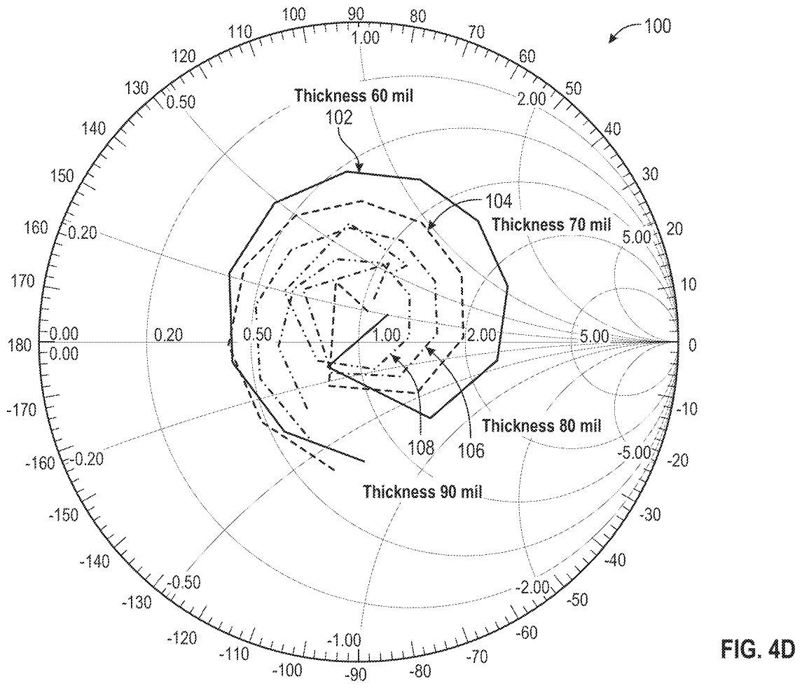

Referring to FIGS. 2A-B, the ridge structure 12 may provide a substrate integrated scan angle invariant impedance matching surface. In this manner, an impedance exhibited by the directionally-tunable antenna element 2 approximately maintains a relative impedance match across a range of scan angles. This facilitates strong performance and/or relatively consistent gain and beamform characteristics as an electronically scanned array (ESA) made up of the directionally-tunable antenna elements 2 is scanned (e.g., steered). FIG. 4A illustrates a ridge structure 12 and FIG. 4B illustrates a ridge structure 12, coupling structure 14, and feed structure 16 with an electromagnetic field also depicted.

Typical phased arrays have directionally-tunable antenna elements that are closely spaced to avoid large degenerate modes called grating lobes from occurring in the prescribed scan volume of the array. To avoid grating lobes, the spacing of the elements must be less than d≤λ/(1 +sinθ) where d is the element spacing, λ is the free space wavelength, and θ is the maximum scan angle of the beam from zenith. Typical element spacing is around a half wavelength. With the tight spacing it is imperative to minimize the inter-element field coupling to adjacent radiators. For any reference element in an array there is an associated reflection coefficient Γ₀, or active impedance of an element, where

Γ₀(θ_{S}, ∅_{S})=Σ_{n,m}S_{c}e^{ψ}^{_{n,m,s}}^{(x}^{_{n,m,}}^{y}^{_{n,m}}⁾.

e^{ψ}^{_{n,m,s}}^{(x}^{_{n,m,}}^{y}^{_{n,m}}⁾ is the general array factor expression for a two-dimensional array at a scan angle (θ, ϕ) in a spherical coordinate system and S_{c} is the complex sum of coupling coefficients between a reference element and its adjacent elements.

FIG. 4C shows a side view of the ridge structure 12. Referring to FIG. 4C, the ridge structure 12 described here provides a substrate integrated scan angle invariant impedance matching surface that minimizes S_{c}, the sum of coupling coefficients, and provides a scan invariant impedance match by a substrate integrated ridge structure 12 that introduces a distributed parallel L-C impedance match 18 to free space. The ridges are composed of metal layers 6 with through-hole vias 20 connecting the metal layers 6 through a substrate 22 with substrate thickness 24 of height h_{sub} and acts to minimize substrate coupling between adjacent elements of an array (directionally-tunable antenna elements 2 of an array 3 (FIG. 3)) since the via spacing of the through-hole vias 20 is sufficient to attenuate lateral field propagation.

The ridges of the antenna structure are roughly equivalent to a ridged waveguide whose impedance is described by a distributed parallel L-C impedance 18 as shown in FIG. 4C which gives a wide band impedance match of typically 18-20%. FIG. 4D illustrates a Smith chart 100 showing that the impedance match of the ridge structure 12 depends on its thickness in a band of interest. The Smith chart 100 illustrates several substrate thicknesses 24 of a substrate 22. For instance, a curve 102 associated with an about 60 mil (about 1.5 mm) thickness, a curve 104 associated with an about 70 mil (about 1.78 mm) thickness, a curve 106 associated with an about 80 mil (about 2.0 mm) thickness, and a curve 108 associated with an about 90 mil (about 2.3 mm) thickness are depicted. A tighter grouping of complex impedance points around a normalized impedance of 1 indicates an optimal impedance match between free space and the directionally-tunable antenna element.

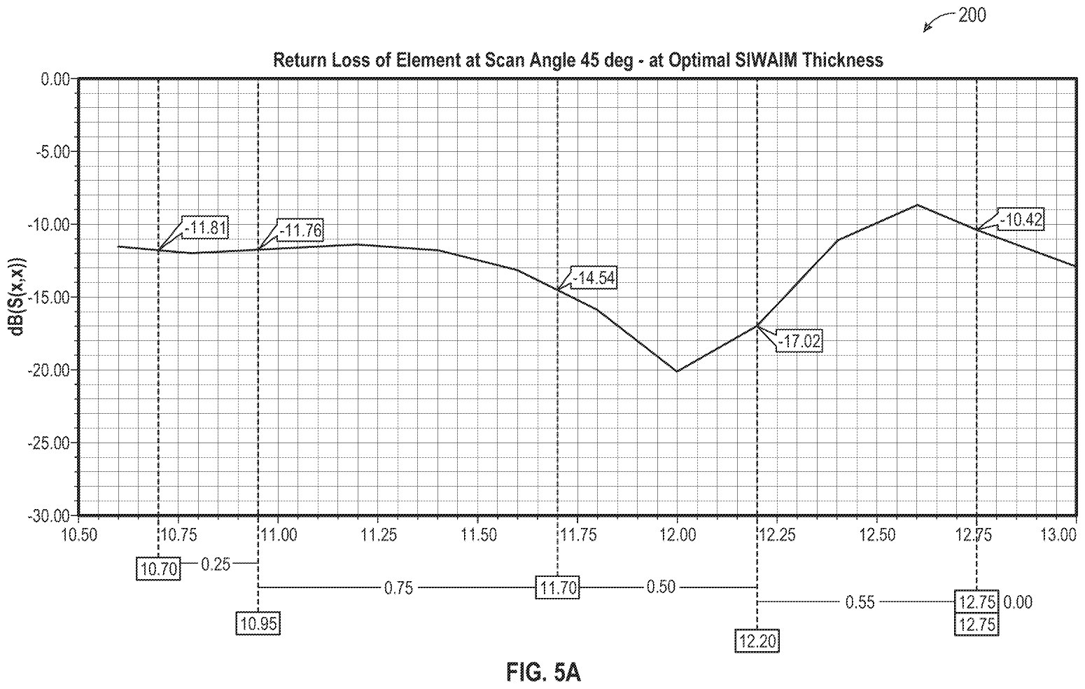

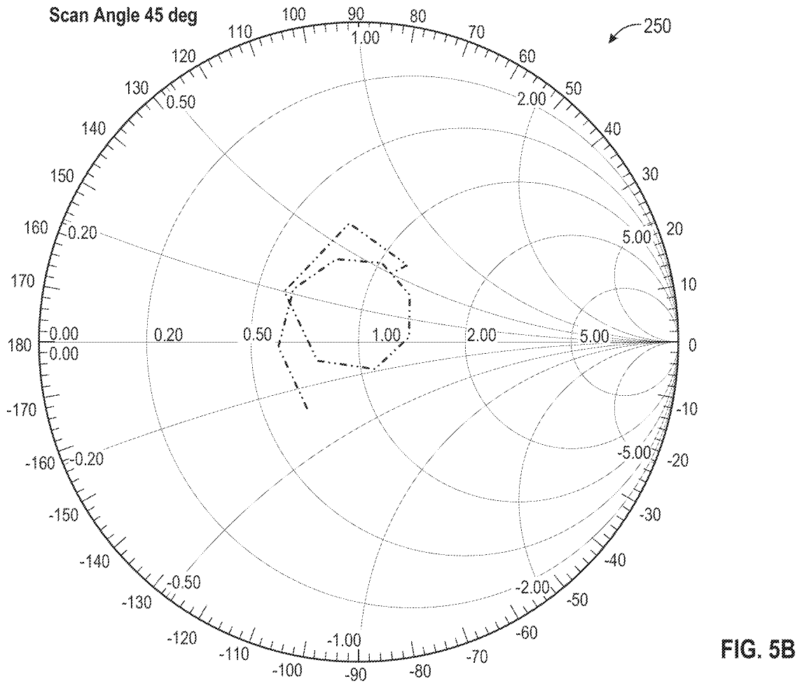

FIGS. 5A-B show a chart 200 of return loss and corresponding impedance chart 250 for the optimal broadband impedance at a 45-degree scan angle. This realization is an outside ridge with an inner patch connected to the bottom of the ridge structure.

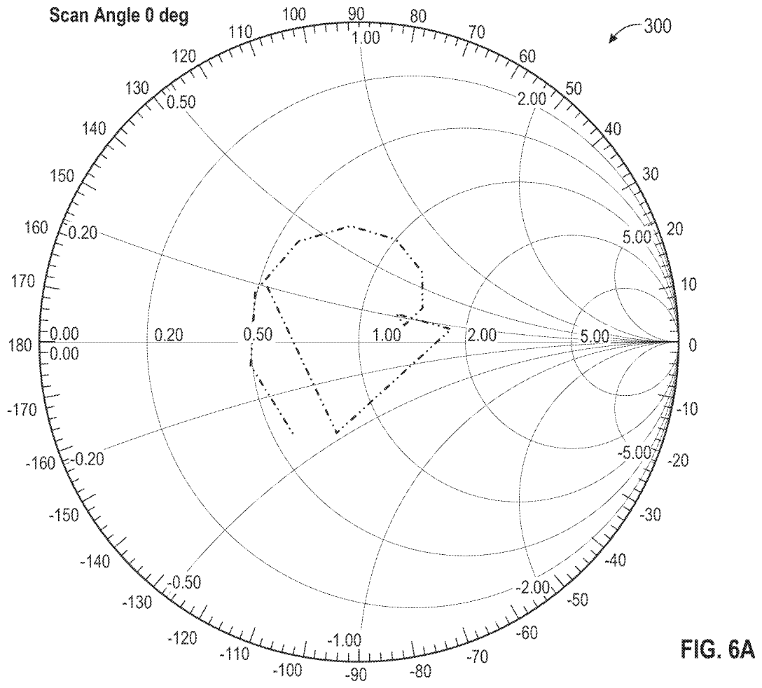

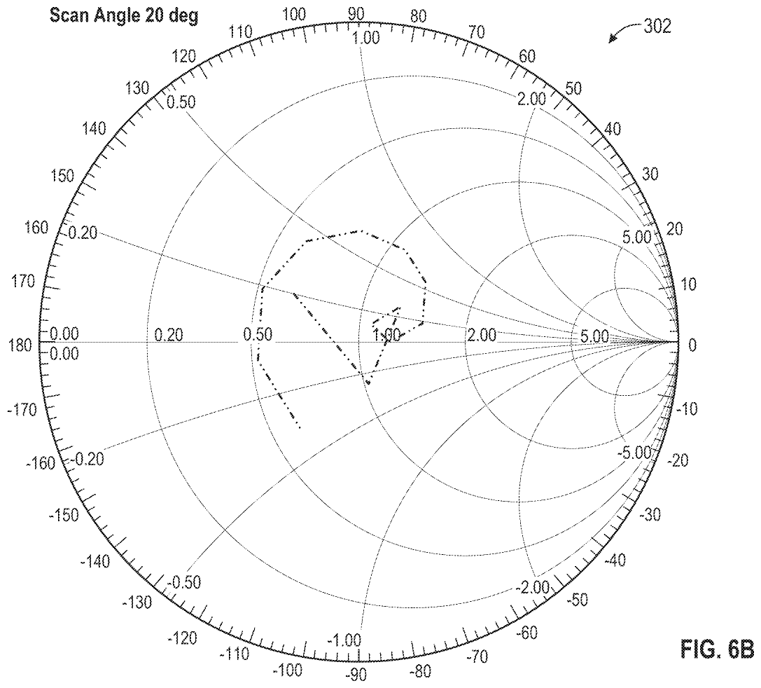

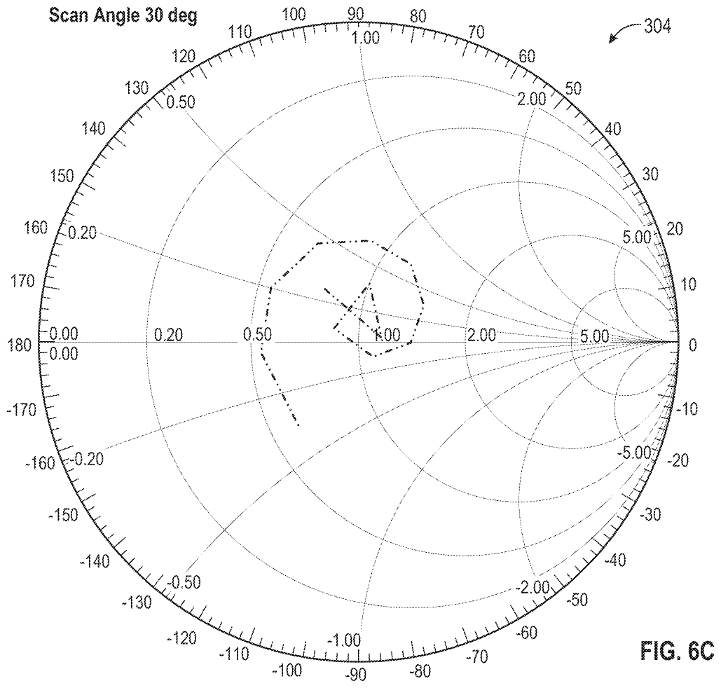

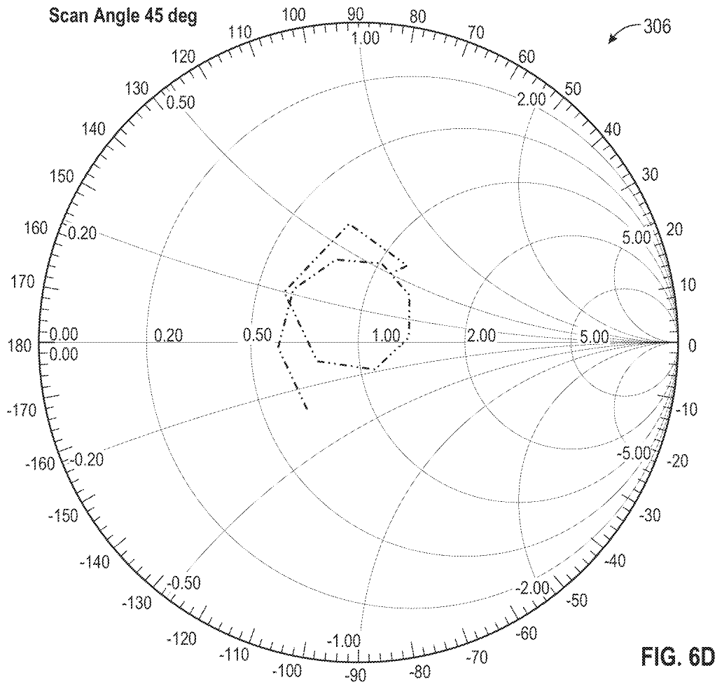

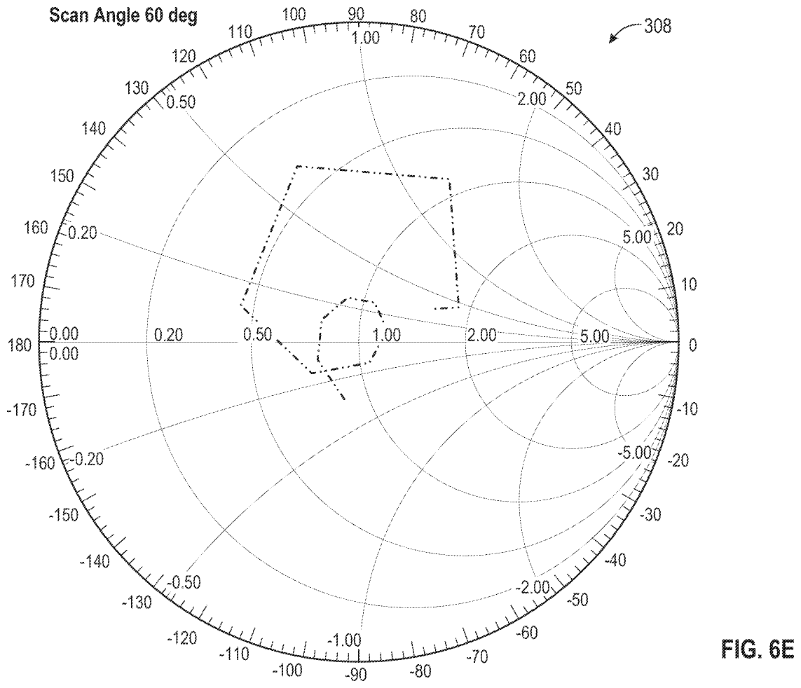

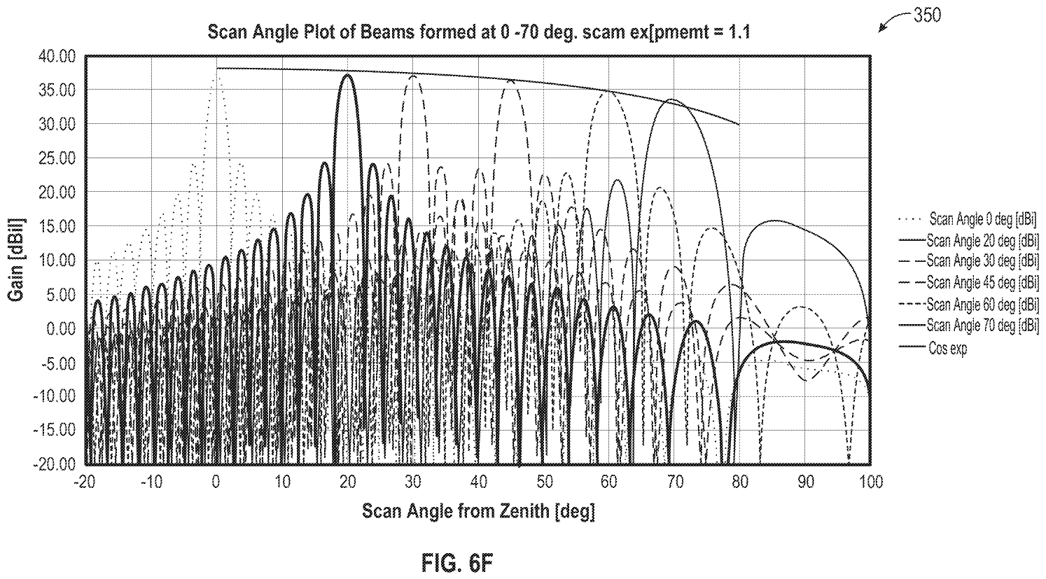

Over the full scan range of the array, the complex impedance remains centered around the normalized impedance. This behavior is due to the minimization of the summed mutual coupling coefficient of adjacent directionally-tunable antenna elements and therefore the surface is scan angle invariant with respect to impedance and peak gain. FIGS. 6A-E shows a collection of Smith charts illustrating complex impedance plots at various scan angles. FIG. 6A shows a Smith chart 300 illustrating a complex impedance plot at a scan angle of about 0 degrees. FIG. 6B shows a Smith chart 302 illustrating a complex impedance plot at a scan angle of about 20 degrees. FIG. 6C shows a Smith chart 304 illustrating a complex impedance plot at a scan angle of about 30 degrees. FIG. 6D shows a Smith chart 306 illustrating a complex impedance plot at a scan angle of about 45 degrees. FIG. 6E shows a Smith chart 308 illustrating a complex impedance plot at a scan angle of about 60 degrees. FIG. 6F shows a scan angle plot 350 corresponding to the scan angles of FIGS. 6A-E. FIGS. 6A-6F show behavior at various scan angles for both impedance and peak gain performance of the array. The “scan exponent” refers to the roll-off of the antenna peak gain as it is scanned off zenith. The exponent loss from the reference angle of zero degrees is expressed as

Scan_loss(θ)[dB]=10log(cos^{lexp}θ)

where lexp is the scan exponent. A scan exponent of 1 is ideal.

A typical scan loss exponent for a patch antenna ranges in the 1.5-1.8 range due to the relatively high S_{c} mutual coupling component. An antenna formed of directionally-tunable antenna elements as provided herein exhibits a surface scan exponent typically in the 1.1-1.2 range indicative of higher suppression of adjacent mutual coupling effects.

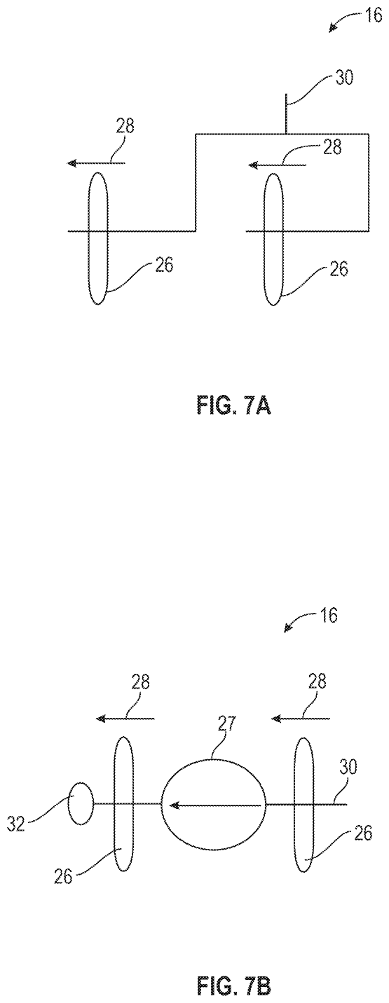

Having discussed various embodiments of the ridge structure 12, attention is now directed to a discussion of various embodiments of a feed structure 16 (FIGS. 2A-B). FIGS. 7A-B show simplified diagrams of different feed structure 16 configurations. The diagrams show a single aperture pair excited by a power splitter and feed to each aperture and the basic concept of the reflective feed. The FIG. 7B illustration consolidates the splitter into two orthogonal sides that are isolated by cancelling fields and eliminates the need for two separate feeds on two separate layers, which lowers complexity.

Specifically, FIG. 7A shows an aperture feed 30 that is a two-point feed with a splitter/combiner to feed the apertures 26 in phase as represented by field direction arrows 28. FIG. 7B shows a reflective feed 30 that consolidates the splitter/combiner with a 180-degree phase shift function 27 allowing the two polarized inputs to be combined into one. Apertures 26 are fed in phase as represented by field direction arrows 28, and with stub 32.

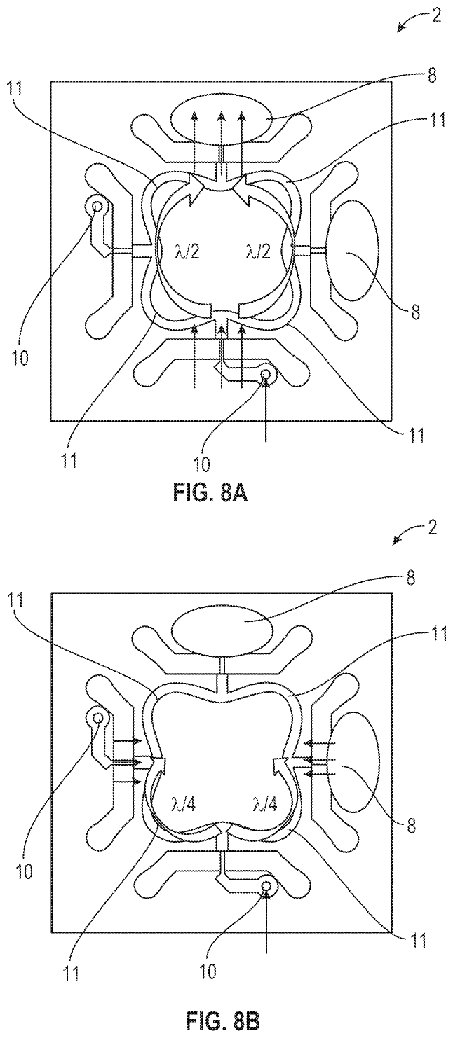

FIGS. 8A-B show a basic configuration of a directionally-tunable antenna element 2. FIG. 8A shows a feed summation path that produces a co-polar field and FIG. 8B shows a feed difference path that produces a cross-polar field. The configuration may be termed a dual linear polarized reflection feed. This feed configuration includes two feed points 10. For example, a feed point 10 may be for connection to a vertically polarized signal, and another feed point 10 may be for connection to a horizontally polarized signal. The feed points 10 are connected and impedance matched to a central ring of phasing traces 11. In addition, the inclusion of the reflective stubs 8 eliminate the need for an in-phase splitter and excitation at both ridge excitation points. This simplifies the feed architecture by realizing the full two port feed in a single layer.

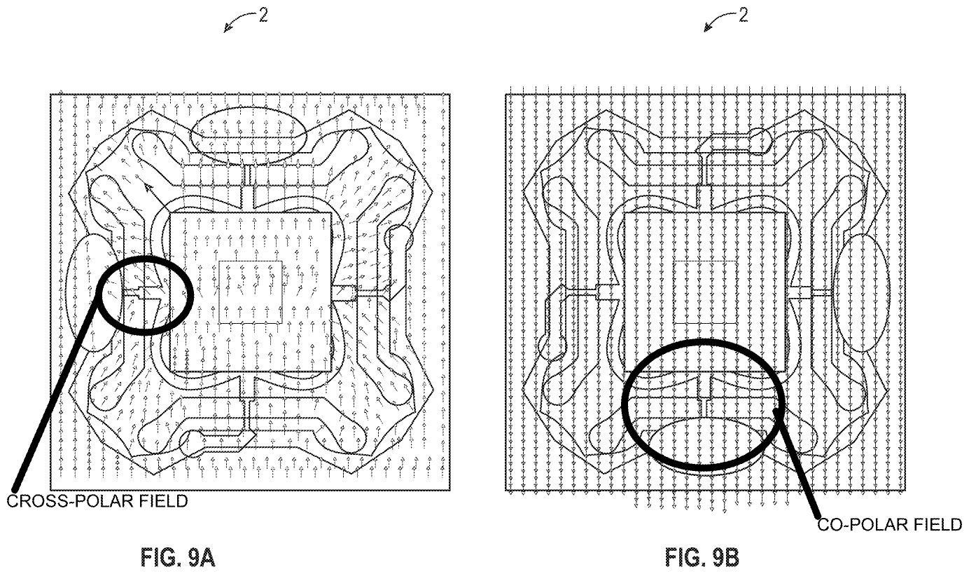

An elliptical stub terminates the opposite side of the ring and provides a matched reflection to the input. The half circle of the ring is ½ wavelength and therefore provides the 180-degree phase shift required to excite the two facing ridges in phase through the coupling structure. Important also is that the ¼ length of the ring at the same time gives canceling fields at the orthogonal port and, in turn, radiates a minimized cross polar field. This mechanism provides both in phase co-polar electric field summing and cross-polar electric field cancellation, which results in enhanced cross-polar suppression. Simulated field patterns are shown in FIGS. 9A-B showing co-polar summation of fields and cross-polar cancelation of fields. FIG. 9A shows fields at a surface of the directionally-tunable antenna element 2, with a cross-polar field identified, and FIG. 9B shows fields at about 100 mils (about 2.54 mm) above a surface of the directionally-tunable antenna element 2, with a co-polar field identified.

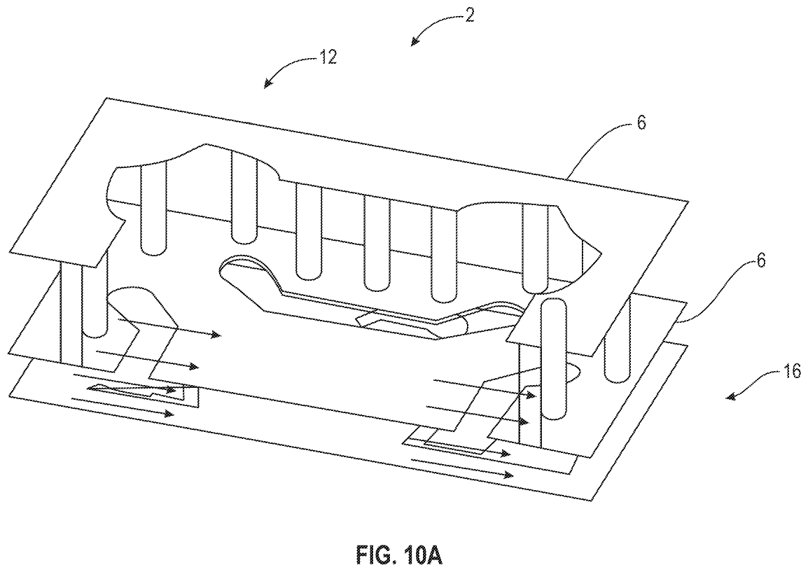

With reference to FIGS. 10A-C, a further aspect of the directionally-tunable antenna element 2 is the electric field coupling mechanism between the reflective feed structure 16 and the ridge structure 12 (ridged scan invariant impedance surface). In one example embodiment, inductively coupled fields are illustrated by the parallel lines in FIG. 10A to depict inductive ground plane aperture coupling. In this configuration, half wavelength slots (apertures 15) in the metal layer 6 that is the lower metal ground plane at the base of the ridge structure 12 inductively couple to the feed structure 16. The feed structure 16 and apertures are separated by a dielectric layer (such as coupling structure 14 (FIG. 2A)) which provides the field coupling. The aperture coupled ground plane provides the widest bandwidth of the field coupling mechanisms.

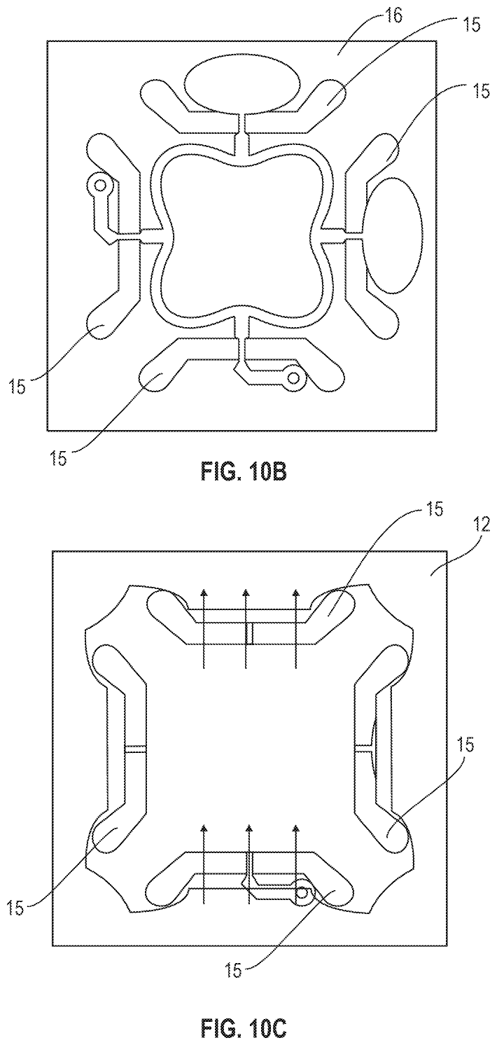

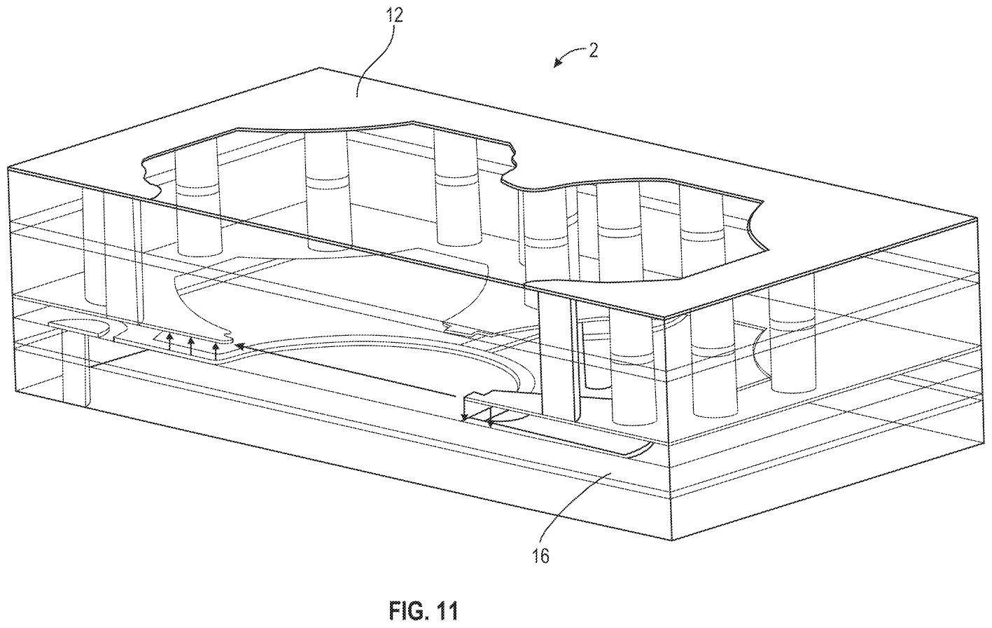

Another embodiment of the field coupling mechanism for the directionally-tunable antenna element 2 is with the ridge structure 12 capacitively coupled to the feed structure 16 as FIG. 11 shows. In this configuration, a base of the ridge structure 12 comes to a point whose area is wide enough that it couples capacitively to the feed structure 16.

Having introduced a variety of embodiments of the directionally-tunable antenna element, one may appreciate various advantageous features of a corresponding antenna configuration. For instance, the system provided herein has a true planar circuit board architecture including a scan angle invariant impedance surface integrated into the board architecture. The directionally-tunable antenna element exhibits broad gain and impedance bandwidth. The architecture may have one to two layers more than a patch element but has a wider bandwidth suitable for Ku receive band of 16%, Ka receive band of 18% without compromising important performance parameters such as flat gain bandwidth and return loss. Moreover, the configuration is not subject to scan blindness at for off axis scan angles. A single point reflective feed satisfies dual polarized operation over a wide bandwidth, while satisfying important performance parameters such as low cross polar gain, low loss. A single point reflective feed uses one feed layer to satisfy dual polar operation. The system provides better scan angle exponent than patch antennas.

Having introduced various aspects and embodiments of a directionally-tunable antenna element 2, and with reference to FIGS. 1A-11, several example implementations may now conveniently be discussed. A directionally-tunable antenna element 2 of an antenna (array 3) may include various features. For instance, a feed structure 16, a coupling structure 14, and a ridge structure 12 may be provided. The feed structure 16 may be connectable to at least one of a transmitter and/or a receiver (e.g., input and/or output). The coupling structure 14 may be adjacent to the feed structure 16. The ridge structure 12 may be adjacent to the coupling structure 14. The coupling structure 14 is disposed between the feed structure 16 and the ridge structure 12. The coupling structure 14 may be configured to communicate electromagnetic energy between the feed structure 16 and the ridge structure 12. The coupling structure 14 may be a dielectric material that capacitively couples the feed structure 16 to the ridge structure 12.

The ridge structure 12 may include two metal layers 6 made of a first metal and sandwiching a substrate 22 layer. A plurality of through-hole vias 20 may connect the two metal layers 6 through the substrate 22 layer. The through-hole vias 20 are made of the first metal. The coupling structure 14 may be a dielectric material that capacitively couples the feed structure 16 to the ridge structure 12. An outermost metal layer 6 of the two metal layers 6 may be a metal edge lying in a plane surrounding and defining a central opening. The outermost metal layer 6 may include a center patch element 13 that is a metal pad in the central opening and separated from the metal edge.

In various embodiments, the feed structure 16 has a plurality of apertures and the ridge structure 12 has a plurality of apertures 15. The apertures of the feed structure 16 and the apertures of the ridge structure 12 have same shapes and are aligned to electromagnetically (e.g., inductively) couple the feed structure 16 to the ridge structure 12. The feed structure 16 may include a first input (feed point 10) to receive a first electromagnetic signal and a second input (feed point 10) to receive a second electromagnetic signal comprising the first electromagnetic signal with a phase delay. The first input (feed point 10) and the second input (feed point 10) may be capacitively coupled inputs.

In various embodiments, the feed structure 16 includes a first input (feed point 10) connected to a plurality of reflective stubs 8 by at least one phasing trace 11 and a second input (feed point 10) connected to the plurality of reflective stubs 8 by at least one further phasing trace 11. Each of the at least one phasing trace 11 and the at least one further phasing trace 11 collectively mix the first input (feed point 10) and the second input (feed point 10) to cause an electromagnetic signal at the first reflective stub 8 to have a different phase than the electromagnetic signal at the second reflective stub 8. A first electromagnetic signal source may be included that that tunes an amplitude and phase of a first portion of the electromagnetic signal at the first input and a second portion of the electromagnetic signal at the second input to cause the directionally-tunable antenna element 2 to steer an emitted beam of the electromagnetic signal responsive to the tuning.

Multiple planar directionally-tunable antenna elements 2 may be combined into an array 3 to provide an antenna. The antenna may be configured to steer one or more lobe of the antenna in response to mixing of a plurality of (i) inputs or (ii) outputs to the antenna.

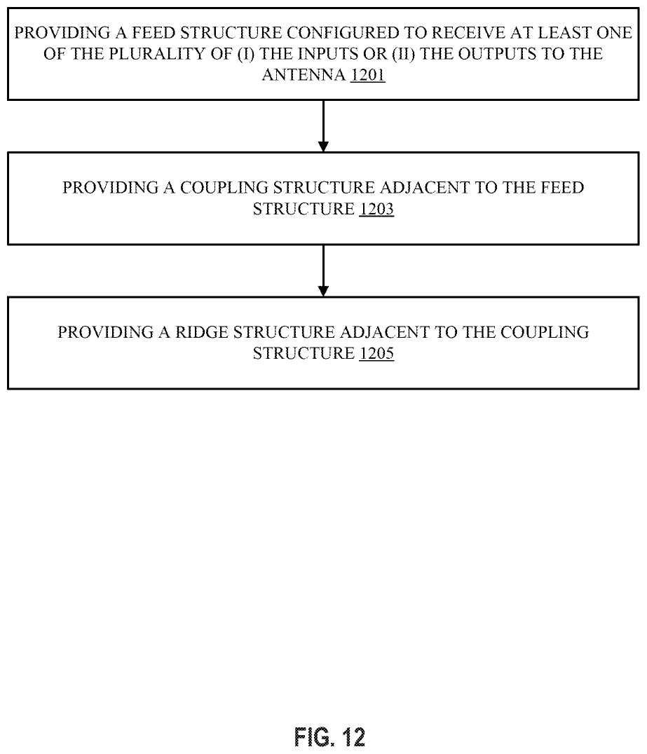

Finally, and with reference to FIG. 12, a method of manufacturing a directionally-tunable antenna element of an antenna comprising an array of directionally-tunable antenna elements may be provided. The antenna may be configured to steer one or more lobe of the antenna in response to mixing of a plurality of (i) inputs or (ii) outputs to the antenna. The method may include providing a feed structure configured to receive at least one of the plurality of (i) the inputs or (ii) the outputs to the antenna (block 1201). The method may include providing a coupling structure adjacent to the feed structure (block 1203). The method may include providing a ridge structure adjacent to the coupling structure (block 1205). The coupling structure may be disposed between the feed structure and the ridge structure. The coupling structure may be configured to communicate electromagnetic energy between the feed structure and the ridge structure.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A directionally-tunable antenna element of an antenna, the directionally-tunable antenna element comprising:
a feed structure that is connectable to at least one of a transmitter and a receiver;
a coupling structure adjacent to the feed structure; and
a ridge structure adjacent to the coupling structure,
wherein the coupling structure is disposed between the feed structure and the ridge structure, and
wherein the coupling structure is configured to communicate electromagnetic energy between the feed structure and the ridge structure.

2. The directionally-tunable antenna element according to claim 1, wherein the ridge structure comprises:
two metal layers made of a first metal and sandwiching a substrate layer; and
a plurality of through-hole vias connecting the two metal layers through the substrate layer.

3. The directionally-tunable antenna element according to claim 2, wherein the plurality of through-hole vias are made of the first metal.

4. The directionally-tunable antenna element according to claim 1, wherein the coupling structure comprises a dielectric material that capacitively couples the feed structure to the ridge structure.

5. The directionally-tunable antenna element according to claim 1, wherein the coupling structure inductively couples the feed structure to the ridge structure.

6. The directionally-tunable antenna element according to claim 1,
wherein the feed structure comprises a plurality of apertures,
wherein the ridge structure comprises a plurality of apertures, and
wherein the apertures of the feed structure and the apertures of the ridge structure have same shapes and are aligned to electromagnetically couple the feed structure to the ridge structure.

7. The directionally-tunable antenna element according to claim 1, wherein the feed structure comprises a first input to receive a first electromagnetic signal and a second input to receive a second electromagnetic signal comprising the first electromagnetic signal with a phase delay.

8. The directionally-tunable antenna element according to claim 7, wherein the first input and the second input are capacitively coupled inputs.

9. The directionally-tunable antenna element according to claim 1, wherein the feed structure comprises:
a first input connected to a plurality of reflective stubs by at least one phasing trace; and
a second input connected to the plurality of reflective stubs by at least one further phasing trace.

10. The directionally-tunable antenna element according to claim 9, wherein each of the at least one phasing trace and the at least one further phasing trace collectively mix the first input and the second input to cause an electromagnetic signal at a first reflective stub to have a different phase than the electromagnetic signal at a second reflective stub.

11. The directionally-tunable antenna element according to claim 10, further comprising a first electromagnetic signal source that tunes an amplitude and phase of a first portion of the electromagnetic signal at the first input and a second portion of the electromagnetic signal at the second input to cause the directionally-tunable antenna element to steer an emitted beam of the electromagnetic signal responsive to the tuning.

12. The directionally-tunable antenna element of the antenna, according to claim 2, wherein an outermost metal layer of the two metal layers comprises a metal edge lying in a plane surrounding and defining a central opening.

13. The directionally-tunable antenna element of the antenna, according to claim 12, wherein the outermost metal layer further comprises a center patch element that is a metal pad in the central opening and separated from the metal edge.

14. An antenna comprising an array of co-planar directionally-tunable antenna elements configured to steer one or more lobe of the antenna in response to mixing of a plurality of (i) inputs or (ii) outputs to the antenna, each of a co-planar directionally-tunable antenna element of the antenna comprising:
a feed structure configured to connect at least one of the plurality of (i) the inputs or (ii) the outputs to the antenna;
a coupling structure adjacent to the feed structure; and
a ridge structure adjacent to the coupling structure,
wherein the coupling structure is disposed between the feed structure and the ridge structure, and
wherein the coupling structure is configured to communicate electromagnetic energy between the feed structure and the ridge structure.

15. The co-planar directionally-tunable antenna element according to claim 14, wherein the ridge structure comprises:
two metal layers made of a first metal and sandwiching a substrate layer; and
a plurality of through-hole vias connecting the two metal layers through the substrate layer.

16. The co-planar directionally-tunable antenna element according to claim 14,
wherein the feed structure comprises a plurality of apertures,
wherein the ridge structure comprises a plurality of apertures, and
wherein the apertures of the feed structure and the apertures of the ridge structure have same shapes and are aligned to electromagnetically couple the feed structure to the ridge structure.

17. The co-planar directionally-tunable antenna element according to claim 14, wherein the feed structure comprises:
a first input connected to a plurality of reflective stubs by at least one phasing trace, and
a second input connected to the plurality of reflective stubs by at least one further phasing trace.

18. The co-planar directionally-tunable antenna element according to claim 17, wherein each of the at least one phasing trace and the at least one further phasing trace collectively mix the first input and the second input to cause an electromagnetic signal at a first reflective stub to have a different phase than the electromagnetic signal at a second reflective stub.

19. The co-planar directionally-tunable antenna element according to claim 18, further comprising a first electromagnetic signal source that tunes an amplitude and phase of a first portion of the electromagnetic signal at the first input and a second portion of the electromagnetic signal at the second input to cause the co-planar directionally-tunable antenna element to steer an emitted beam of the electromagnetic signal responsive to the tuning.

20. A method of manufacturing a directionally-tunable antenna element of an antenna comprising an array of directionally-tunable antenna elements configured to steer one or more lobe of the antenna in response to mixing of a plurality of (i) inputs or (ii) outputs to the antenna, the method comprising:
providing a feed structure configured to receive at least one of the plurality of (i) the inputs or (ii) the outputs to the antenna;
providing a coupling structure adjacent to the feed structure; and
providing a ridge structure adjacent to the coupling structure,
wherein the coupling structure is disposed between the feed structure and the ridge structure, and
wherein the coupling structure is configured to communicate electromagnetic energy between the feed structure and the ridge structure.
